(19) United States
(12) Patent Application Publication
(10) Pub. No.: US 2011/0209070 A1
(43) Pub. Date: Aug. 25, 2011

(54) COLLABORATIVE DEVELOPMENT METHOD AND SYSTEM

(75) Inventors: Robin Lowry, Pointe-Claire (CA); Yannick Desjardins, Repentigny (CA)

(73) Assignee: RYMA TECHNOLOGY SOLUTIONS, Montreal (CA)

(21) Appl. No.: 13/099,570

(22) Filed: May 3, 2011

Related U.S. Application Data
(63) Continuation of application No. 12/174,702, filed on Jul. 17, 2008, now abandoned.
(60) Provisional application No. 60/951,976, filed on Jul. 26, 2007.

(51) Int. Cl. G06F 3/01

(52) U.S. Cl. 715/751

(57) ABSTRACT

The present solution relates to a system and method for collaborative development. The method comprises a displaying of a reference corresponding to at least one information of a development work. Upon selection of the reference a rooting source is accessed for at least one information of a development work. The method furthermore comprises enabling modifications of a content of a field corresponding to the at least one information within the rooting source.

### RELATED APPLICATIONS

This application is a continuation of U.S. application Ser. No. 12/174,702, filed Jul. 17, 2008, which claims the benefit of U.S. Provisional Application No. 60/951,976, filed Jul. 26, 2007, the contents of which is incorporated herein by reference.

### FIELD OF THE INVENTION

The present solution relates to the field of knowledge consolidation and collaborative document development.

### BACKGROUND OF THE INVENTION

In today's working environment productivity of an organization has become one of the key elements to success. Another known key element to success is the quality of work that an organization produces. To reach a higher level of productivity while maintaining a desirable level of quality of work, organizations have learned that teamwork, amongst others, is an important factor in increasing productivity and quality.

Although teamwork has been recognized as a key solution and has been widely implement through out modern organizations, there is still however in some cases a resistance towards teamwork. For some teamwork is, to a certain extent, counter-productive. As a matter of fact, teamwork requires a certain amount of effort for it to be properly implemented. Among other elements, teamwork consists of communicating with team members, consolidating knowledge from team members, convincing other team members and in some instances, obtaining consensus of team members.

One of the elements requiring a great amount of effort is the consolidation of knowledge in a team. For instance, a set of sections in a document requiring to be reviewed by team members with different areas of knowledge is widely distributed by a sender. Cooperative team members pick up the send version of the document and select the sections that concern their area of knowledge. Each team member prepares an email with their comments concerning the selected set of sections in the document. The sender must then relate each received comment to the section and filter out any duplicate comments. In addition, the sender must settle any diverging comments of team members. This way of working is very discouraging and doesn't assure the full participation of every concerned team member.

Some teams operate however differently, in some organizations team meetings are called for a peer review or knowledge consolidation. This way of handling the matter however monopolizes all invited team members for a given period of time. Many complain that team meetings are not very efficient as it is not all team members that contribute equally during the duration of the meeting as areas of knowledge differ for each team member. Furthermore, unnecessary team members might be invited to the meeting and other useful team members might have been disregarded. This way of operating is not always the most efficient and can be regarded as undemocratic. Furthermore, traceability of each team member's input is difficult.

Several software tools such as file version control tools have been developed to manage changes to a given file. However separate sections of a file cannot be independently managed. Version control and change description are maintained at the file level. In this case, each team member accesses a file containing information that concerns several areas and finds the sections that concerns his area of knowledge. Additionally, documents containing confidential sections that should only be reviewed by a sub-group of team members must not be accessible to the others. Consequently, if the same document contains sections that must also be reviewed by all team members or by another sub-group of team members, the version control tool is inadequate for such use.

The current ways of working and the current available tools do not allow efficient consolidation of knowledge for documents that require the input or review of team members with different levels of responsibility or having different areas of knowledge.

### SUMMARY OF THE INVENTION

The present solution relates to a collaborative development method and system. More precisely, the collaborative development method and system enables team members such as remotely located team members to contribute independently to a development work. Moreover the solution enables team members to access the development work according to their own area of expertise, level of responsibility, access privileges or any other type of characteristic.

The system and method includes a rooting source that holds information with respect to the development work. Team members are granted access to add or update content of particular fields in the rooting source. Moreover, the addition and update of the content of the fields in the rooting source are facilitated by an interface that allows team members to make changes to the rooting source without having knowledge of the rooting source architecture.

According to an embodiment of this solution, the system and method enables team members to review the additions and updates made previously by other team members. A detailed history of the changes made by team members is stored in the rooting source.

### BRIEF DESCRIPTION OF THE DRAWINGS

These and other features of the present solution will become more apparent from the following description in which reference is made to the apparent drawings wherein:

FIG. 1a is a flowchart diagram of a method for collaborative development, in accordance with an embodiment of the invention;

FIG. 1b is a flowchart diagram of a method for contributing to development work, in accordance with an embodiment of the invention;

FIG. 1c is a flowchart diagram of a method for creating development work, in accordance with an embodiment of the invention;

FIG. 2 is a dataflow diagram of a system for collaborative development, in accordance with an embodiment of the invention;

FIG. 3 is a development work, in accordance with an embodiment of the invention;

FIG. 4 is an interface for the development work creation, in accordance with an embodiment of the invention;

FIG. 5A is an interface for the development work distribution, in accordance with an embodiment of the invention;

FIG. 5B is an interface for the development work distribution, in accordance with an embodiment of the invention;

FIG. 6 is an interface for the development work updater, in accordance with an embodiment of the invention;

FIG. 7 is a completed development work, in accordance with an embodiment of the invention.

### DETAILED DESCRIPTION OF EMBODIMENTS OF THE INVENTION

The present solution relates to a collaborative development method and system. More specifically, the collaborative development method and system enables team members, such as for example remotely located team members, to contribute independently to a development work. Although the contribution of each team member to the development work is done independently, the development method allows team members with specific areas of knowledge or specific areas of responsibility to make contributions to the development work concurrently. Although the contributions to the development work are done concurrently and independently, each team member has access to the latest contributions. Consequently, as soon as the team member makes a contribution to the development work, other team members with the proper access privileges have access to the latest version of the development work.

Contrary to its prior art, this method and system allows team members to contribute to the development work remotely at their leisure. Additionally, prior made contributions to the development work are made available to all team members that have the proper access privileges. The access privileges are set according to a specific information reference composing the development work. For instance, according to an embodiment of this solution, the development work consists of a Marketing Requirement Document. The Marketing Requirement Document is made of several information references each corresponding to a specific expertise. To encourage team members to contribute to the Marketing Requirement Document, each information reference is easily accessible yet proper access privileges are required to view and contribute to a particular information type.

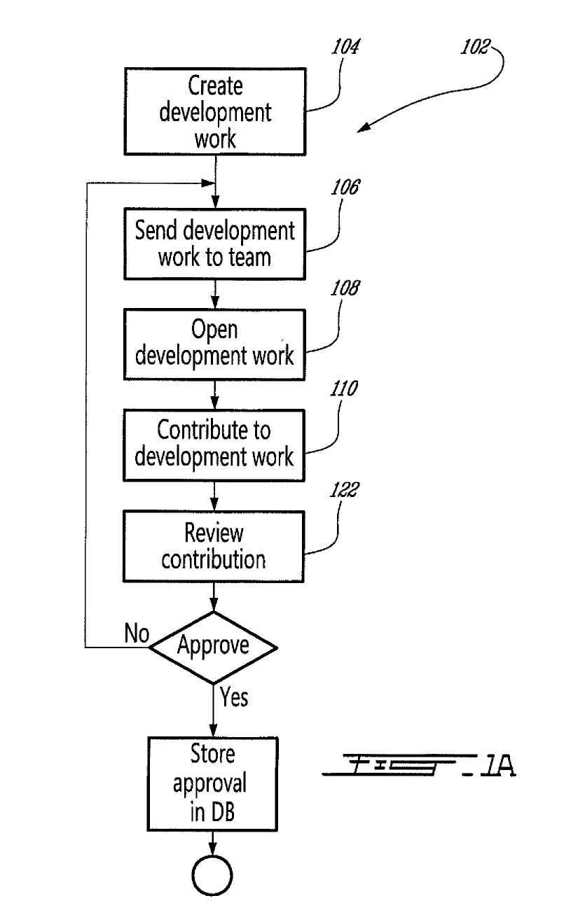

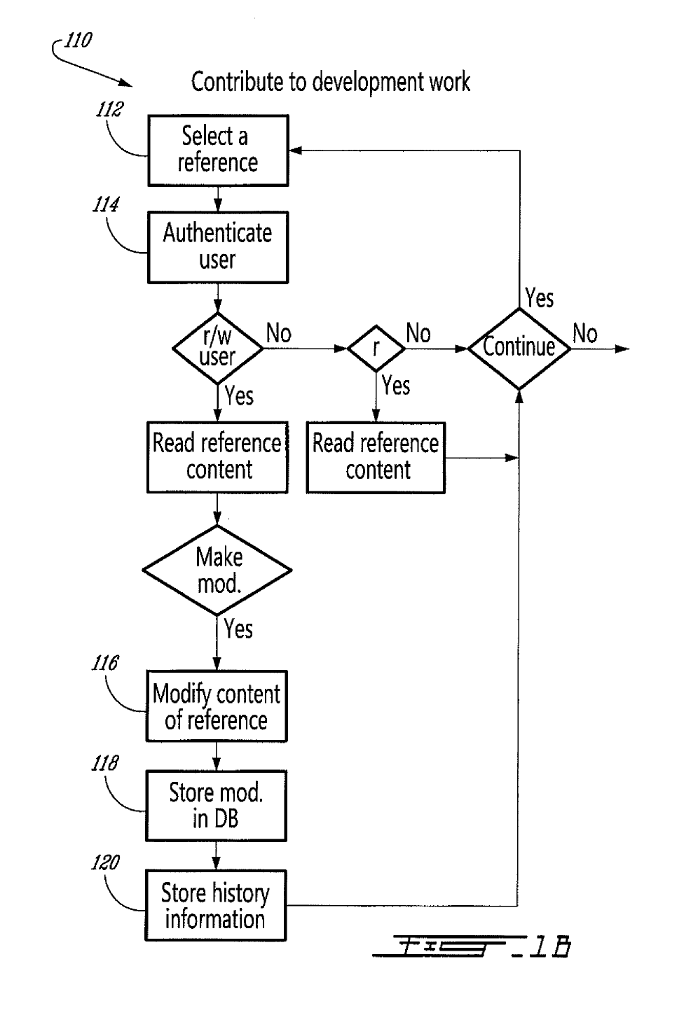

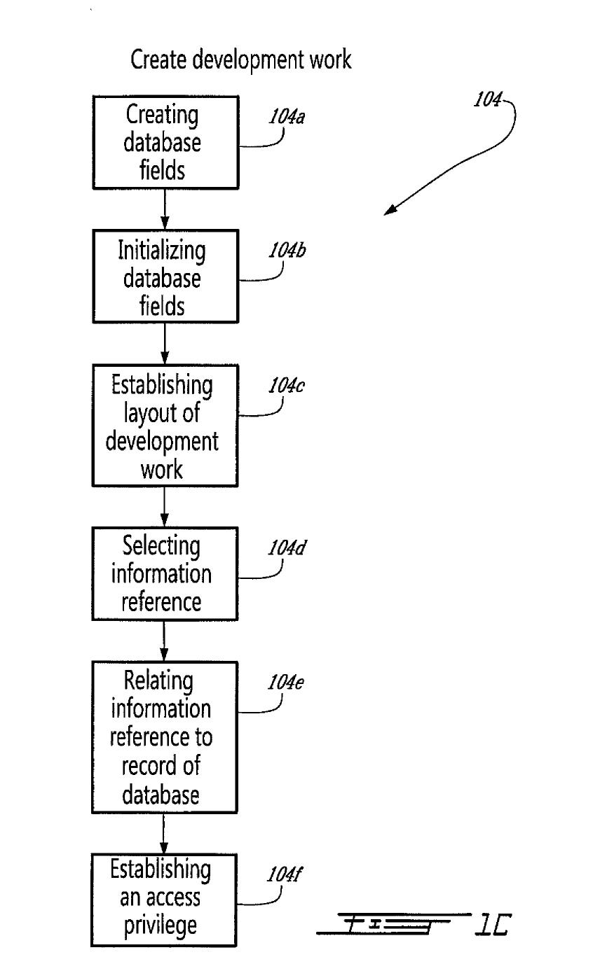

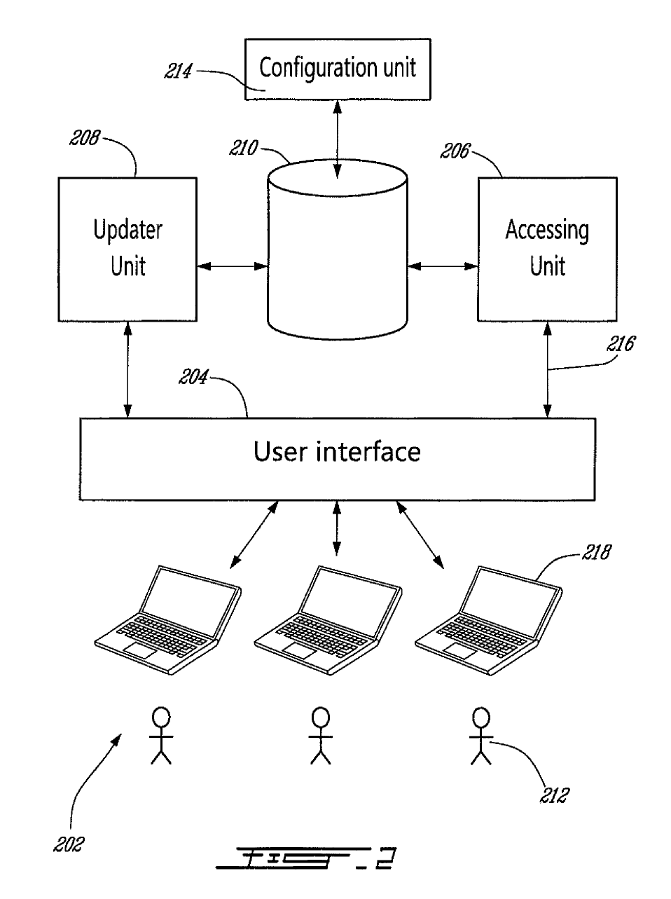

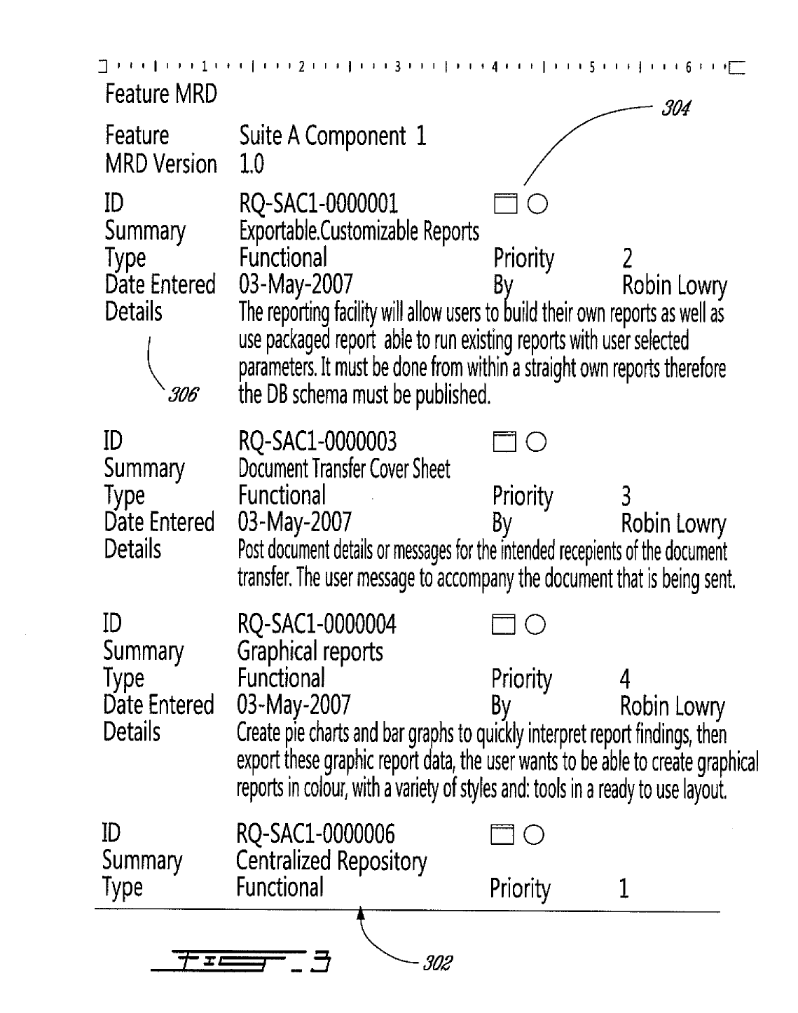

According to an embodiment of this solution, a method 102 for collaborative development is presented in FIG. 1a. The method 102 includes sequential steps and may be executed recursively. The first step of the method 102 is a “create development work” step 104. The “create development work” step 104 consists of creating a draft of a development work 302 to which contributions are desired, as concurrently presented in FIG. 3. Concurrently presented in FIG. 2, according to an embodiment of this solution, a system for collaborative development 202 is presented. The system for collaborative development 202 comprises a user interface 204 that interfaces users with an accessing unit 206 and an updater unit 208. The updater unit 208 processes any manipulation of information for fields of a rooting source 210. The accessing unit 206 retrieves information stored in the fields of the rooting source 210 and presents them according to a layout.

According to another embodiment of this solution, the system for collaborative development 202 furthermore comprises a configuration unit 214. The configuration unit 214 allows setting rooting source 210 field values. In other words, the configuration unit 214 facilitates the management of collaborative development. Consequently, the configuration unit 214 allows setting field values of the rooting source 210 relating to elements of the development work 302 as concurrently presented in FIG. 3. People skilled in the art will acknowledge that the rooting source 210 may be a database, a relational database, a spreadsheet or any other means of storing information. In other embodiments of the solution, the configuration unit 214 allows setting team member 212 properties such as access privileges, responsibility areas, expertise areas, etc.

According to an embodiment of this solution, the user interface 204, the accessing unit 206, the updater unit 208, the rooting source 210, and the configuration unit 214 are software tools. People skilled in the art will however acknowledge that in some embodiments, a partial set of the system for collaborative development 202 are software tools.

According to another embodiment of this solution, the system for collaborative development 202 furthermore comprises a communication network 216. The communication network 216 allows remotely located components of the system for collaborative development 202 to communicate and interact. People skilled in the art will recognize that the remotely located components using the communication network 216 may be a subset or all the components of the system for collaborative development 202. The components of the system for collaborative development 202 consist of the user interface 204, the accessing unit 206, the updater unit 208, the rooting source 210 and the configuration unit 214.

Returning to FIG. 1a, the “create development work” step 104 consists of creating and setting the required elements that need to be made available in the development. According to an embodiment of this solution, as presented in FIG. 1c, the “create development work” step 104 further consists of a “creating database fields” step 104a followed by a “initializing database fields” step 104b which consist of creating and initializing the necessary fields in the rooting source 210 that are required in the development work 302 as concurrently presented in FIG. 2 and FIG. 3. People skilled in the art will recognize that the fields of the rooting source 210 do not necessarily all need to be initialized depending on their usage in the development work 302.

According to another embodiment of this solution, following the “initializing database fields” step 104b, an “establishing layout of development work” step 104c is further presented in FIG. 1c. The “establishing layout of development work” step 104c, consists of selecting the fields that should be presented and the fashion in which they should be presented in the development work 302. People skilled in the art will recognize that the layout may be a predetermine layout. Alternatively, the layout may be determined based on the privileges of the collaborating team members.

According to another embodiment of this solution, following the “establishing layout of development work” step 104c, a “selecting information reference” step 104d is further presented in FIG. 1c. As concurrently presented in FIG. 2 and FIG. 3, the “selecting information reference” step 104d consists of determining and selecting the information references 304 that should be added to the development work 302. According to an embodiment of this solution, the “selecting information reference” step 104d is facilitated by the “configuration unit” 214.

According to another embodiment of this solution, following the “selecting information reference” step 104d, a “relating information reference to record of database” step 104e is further presented in FIG. 1c. As concurrently presented in FIG. 2 and FIG. 3, the “relating information reference to record of database” step 104e consists of relating a selected information reference 304 to a record of the rooting source 210. Furthermore, the information reference 304 may be related to more than one record of the rooting source. Consequently, a different record may be accessed by team members depending on a single or a combination of properties. People skilled in the art will recognize that these properties may be user-based properties, time and date based properties, layout type properties, etc. According to an embodiment of this solution, the “relating information reference to record of database” step 104e is facilitated by the “configuration unit” 214.

According to an embodiment of this solution, following the “relating information reference to record of database” step 104e, an “establishing an access privilege” step 104f is further presented in FIG. 1c. The “establishing an access privilege” step 104f consists of establishing an access privilege for team members to an information reference 304 as concurrently presented in FIG. 3. People skilled in the art will however recognize that the access privilege may be set at other levels such as at the development work 302 level, at a super-group of information references 304 level, at a sub-group of information references 304 level, at an information reference type 306 level, etc. According to an embodiment of this solution, the “establishing an access privilege” step 104f is facilitated by the “configuration unit” 214.

The above-mentioned details of the “create development work” step 104 steps are furthermore removable, interchangeable or combinable. Moreover, people skilled in the art would also understand that in some cases additional steps are interposable.

Following the “create development work” step 104, as further presented in FIG. 1a and concurrently presented in FIG. 2 and FIG. 3, is a “send development work to team” step 106. The “send development work to team” step 106 consists of making the development work 302 available to via client devices 218 other team members 212. People skilled in the art will recognize that the client device 218 may be a computer, a Personal Digital Assistant, a phone or any other means of accessing information. Although, in this embodiment, the development work 302 is sent via email, it is however possible to distribute the development work 302 via any other distribution medium. The distribution medium consists of any suitable storage means or publication means that is accessible to other team members 212 such as a single or a combination of the following: a web page, a network drive, a hard drive, a memory card, a USB memory stick, a floppy disk, etc. People skilled in the art will acknowledge that the development work 302 may be scheduled to be distributed more than once or on a regular basis. The development work 302 may be send during a certain period of time at certain milestones, so as to continuously encourage the following up of the development work 302.

According to an embodiment of this solution, the collaborative development system 202 sends development work 302 to team members 212 having only a certain set of privileges or properties. People skilled in the art will acknowledge that it would be possible for each team member 212 to obtain a different layout when selecting the reference, depending on their expected contribution. Additionally, according to an embodiment of this solution, the team member 212 reception information such as addresses, reception method, reception scheduling, etc. are stored in the rooting source 210. The setting of the reception information may be facilitated by the “configuration unit” 214.

Following the “send development work to team” step 106, as further presented in FIG. 1a, is an “open development work” step 108 that consists of having the team members 212 accessing independently, concurrently or even simultaneously, the development work. In this embodiment, the development work 302 is accessed through a user interface unit 204 and is processed by the accessing unit 206 as concurrently presented in FIG. 2. People skilled in the art will recognize that other ways of accessing the development work 302 are possible as concurrently presented in FIG. 3. Consequently any other third party system able to interpret the development work 302 should be considered. According to an embodiment of this solution, the development work 302 is a report in the form of a pdf file.

Following the “open development work” step 108, presented in FIG. 1a and concurrently presented in FIG. 2 and FIG. 3, is a “contribute to development work” step 110. According to an embodiment of this solution, the “contribute to development work” step 110 consists of individual team members 212 making a contribution to the development work 302. According to an embodiment of this solution, the contribution is a comment for a particular information reference 304 of the development work 302. According to another embodiment of this solution, the contribution consists of an update, an addition or a deletion to the content of the actual information reference 304.

Details of the “Contribute to development work” step 110 are further presented in FIG. 1b. As concurrently presented in FIGS. 2 and 3, a “select a reference” step 112 consists of team members 212 that desire to view or make a contribution to a specific information reference 304 to select the specific information reference 304. People skilled in the art will recognize that the team member 212 may select multiple information references 304 all at once. Alternatively, a reference may be unselected by the team member 212 in the case the team member changes his mind. Furthermore, a contribution may be cancelled by the team member 212 in the case the team member changes his mind.

According to an embodiment of the method 102, as presented in FIG. 1a and concurrently presented in FIG. 1b, following the “select a reference” step 112 is an optional “Authenticate User” step 114. In this embodiment each team member 212 attempting to view or make a contribution is authenticated base of its previously defined user access privilege. According to an embodiment of this solution, a team member 212 either has no permission, a read permission or a read and write permission to access a particular information reference 304. People skilled in the art will recognize that other types of access privileges may be defined in other embodiments of this solution. Furthermore, according to another embodiment, the “Authenticate user” step 114 may be placed earlier in the method 102.

According to an embodiment of the method 102, following the “Authenticate user” step 114, a “modify content of reference” step 116 is presented in FIG. 1b. In this step, the team member 212 makes the desired modifications as concurrently presented in FIG. 2. According to an embodiment of the solution a modification consists of placing a comment to the referenced information 304. According to another embodiment of this solution, the modification consists of an update, an addition or a deletion to the content of the information reference 304. People skilled in the art will recognize that the information reference 304 may be any kind of digital information such as data, an image, graph, spreadsheet, document, software code, etc.

Following the “modify content of reference” step 116, according to an embodiment of this solution, is presented in FIG. 1b, a “store modification in database” step 118. The “store modification in database” step 118 consists of storing in the rooting source 210 the modifications made to the referenced information 304 as concurrently presented in FIG. 2 and FIG. 3. The modification to the referenced information 304 is stored in the rooting source 210 with the updater unit 208. The modifications are stored in the rooting source 210 specifically for the particular referenced information 304 and are then accessible for future consultation. People skilled in the art will recognize that in other embodiments of this solution, the rooting source 210 may be replaced by any other suitable storing means.

Following the “store modification in database” step 118, a “store history information” step 120 is presented in FIG. 1b. According ₜo an embodiment of this solution, the “store history information” step 120 consists of storing in the rooting source 210 as presented in FIG. 2, the date and time at which the modification was made. Additionally, the “store history information” step 120 consists of storing in the rooting source 210 the team member 212 identification by which the modification was made. People skilled in the art will recognize that the history information may be stored in another rooting source or in any other suitable means of storage.

The above-mentioned steps are furthermore removable, interchangeable or combinable. Moreover, people skilled in the art would also understand that in some cases additional steps are interposable.

Returning to FIG. 1a, following the “contribute to development work” step 110, a “review contribution” step 122 is presented. The “review contribution” step 122 consists of having a single or a group of team members 212 review the contributions that have been made by all concerned team members 212, concurrently presented in FIG. 2. Consequently, the “review contribution” step 122, consists for each reference that has been modified to either approve or disapprove the contribution. According to an embodiment of this solution, in the case of an approval of the contribution, the approval is stored in the rooting source 210. Alternatively, in the case of disapproval for a given contribution, the development work could be sent back to the concerned team members 210. People skilled in the art will recognize that following the approval of the contributions, the contributions previously stored in the rooting source 210 may be removed, in case of lack of space. People skilled in the art will recognize that the “review of the contribution” step 122 may be done once all contributions have been submitted or intermittently done while contributions are being made at “contribute to development work” step 110.

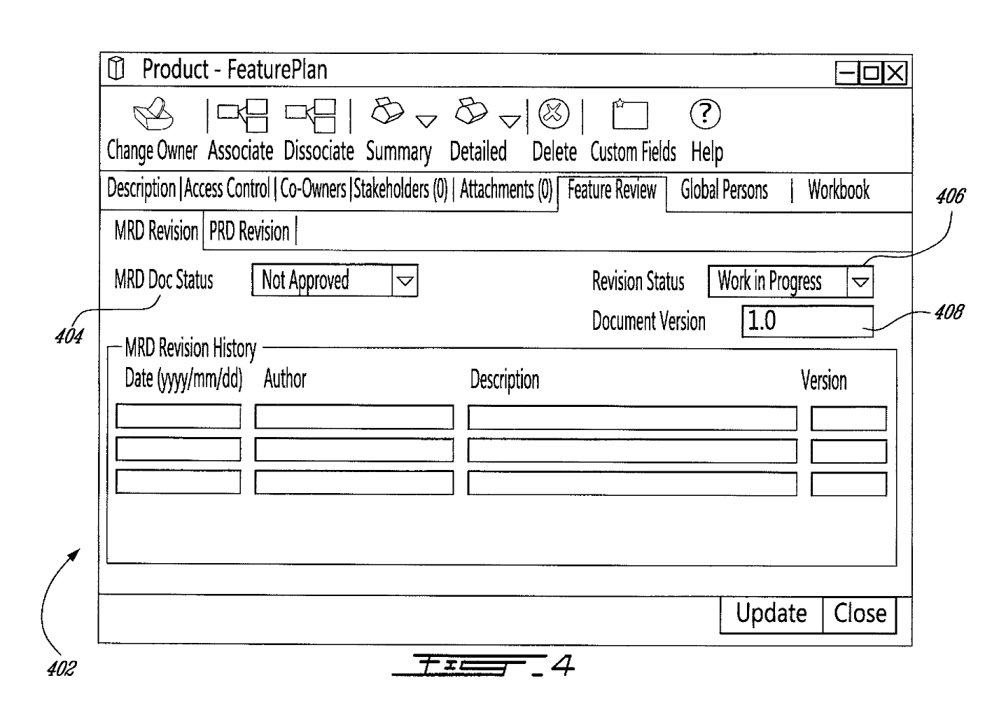

Presented in FIG. 4, in accordance with an embodiment of the solution, is presented a development work creation interface 402. The development work creation interface 402 is a configuration unit 214 that facilitates the creation of a new development work 302 as concurrently presented in FIG. 2 and FIG. 3. In this embodiment, the development work creation interface 402 is a software tool that communicates with the rooting source 210 and allows setting the initial parameters of a development work 302. In this embodiment the initial parameters are development work status 404, development work revision status 406 and development work version 408. It will be appreciated by people skilled in the art that other initial parameters may be set within the development work creation interface 402.

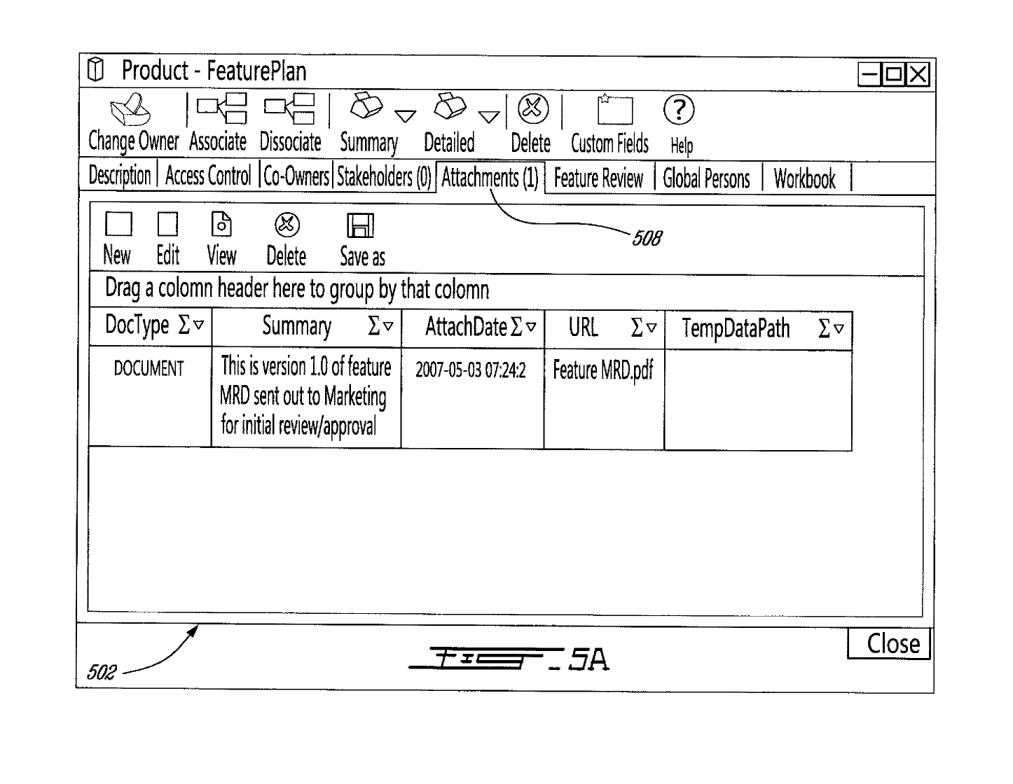

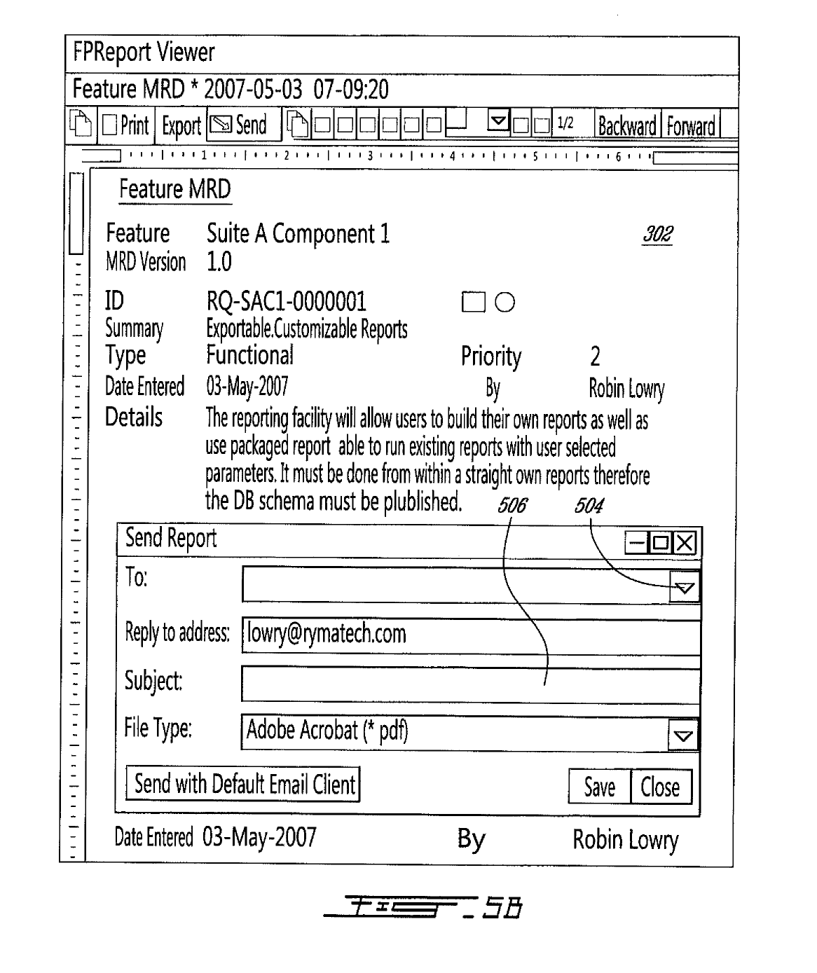

Further presented in the FIG. 5A and FIG. 5B, in accordance with an embodiment of the solution, is presented a development work distribution interface 502. The development work distribution interface 502 is a tool for mailing to team members a development work 302 as concurrently presented in FIG. 3. A recipient field 504 and a subject field 506 are inputs that are suggested for sending out the development work 302 to the team members 212. Additionally an attachment tab 508 is available for attaching the development work 302 to be sent.

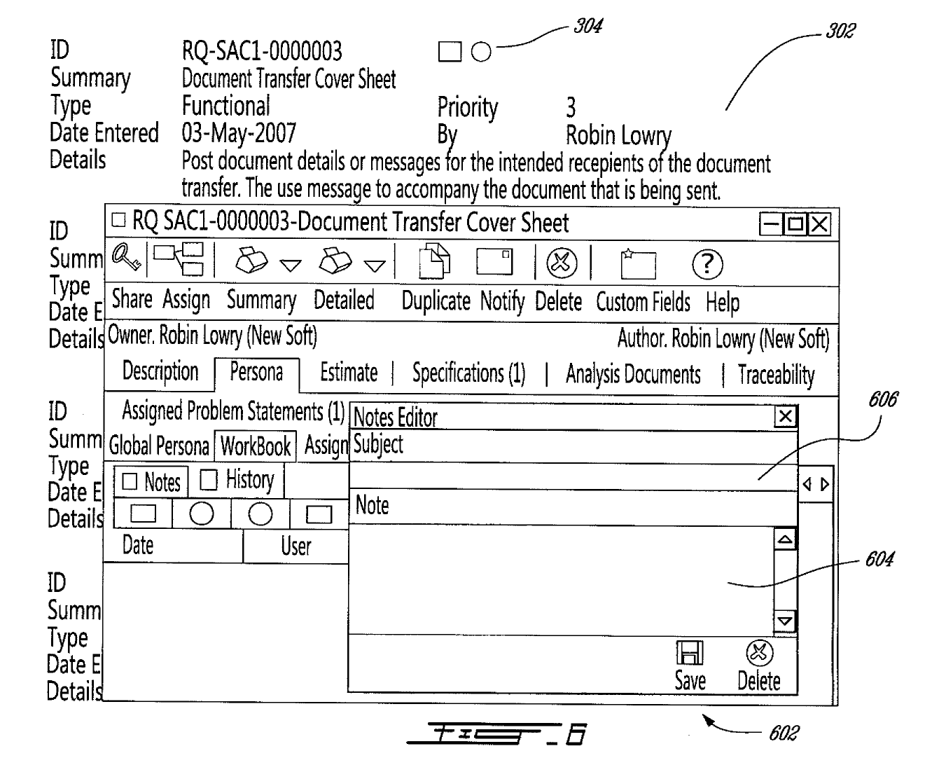

Presented in the FIG. 6, according to an embodiment of the solution, is presented a development work updater interface 602. The development work updater interface 602 is an updater unit 208 that allows storing modifications of field values into the rooting source 210 as concurrently presented in FIG. 2. According to this embodiment the modifications are comments that are added to a specific information reference 304 through a comment editor 604 and a subject field 606. It will be appreciated by people skilled in the art that other team members 212 may afterwards contribute to a thread corresponding to the subject field 606.

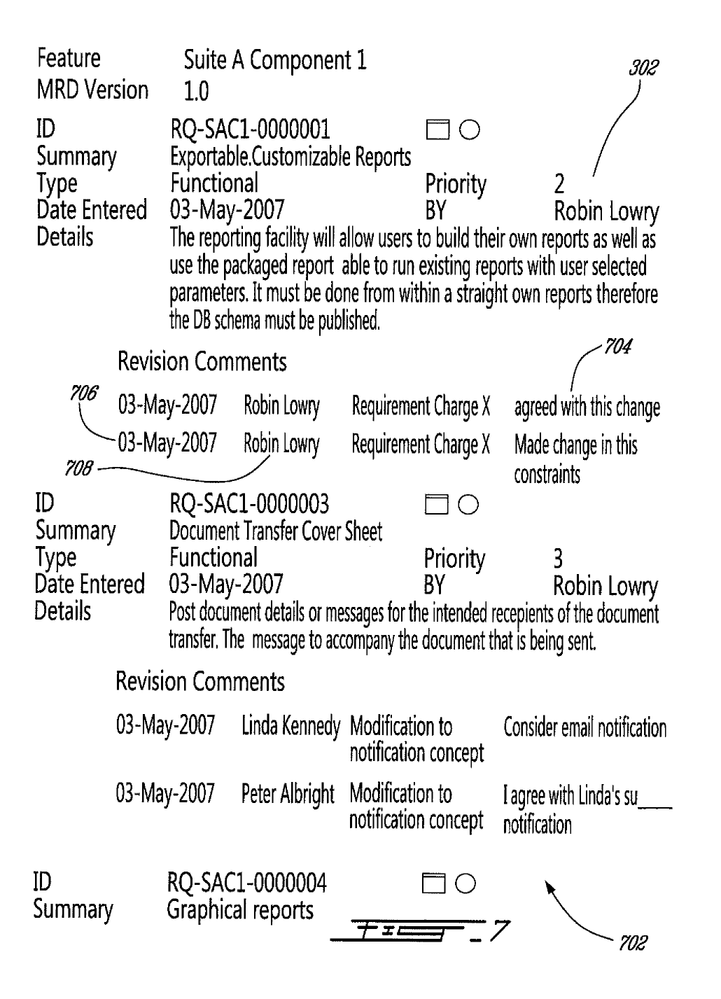

Presented in FIG. 7 is a completed development work 702, in accordance with an embodiment of this solution. The completed development work 702 includes the development work 302 along with a history of changes 704 that consist of comments that have been added by team members 212. The history of changes 704 are displayed within the development work 302 and details a date 706 and an authors 708. People skilled in the art will recognize that other details of changes may be presented in the history of changes 704. Additionally, any other types of changes to the development work 302 other than comments may be displayed in the same fashion or through another interface that is independent of the development work 302. According ₜo an embodiment of this solution, the completed development work 702 is afterwards submitted for approval.

According to an embodiment of this solution, the collaborative development method and system is not only a method and system for accessing collaborative development but also a method and system for managing collaborative development.

The present method and system have been described with regard to preferred embodiments. The description as much as the drawings were intended to help the understanding of the method and system, rather than to limit its scope. It will be apparent to one skilled in the art that various modifications may be made to the solution without departing from the scope or the solution as described herein, and such modifications are intended to be covered by the present description.

1. A method for enabling collaborative development, the method comprising:
displaying a reference corresponding to at least one information of a development work;
upon selection of the reference, automatically accessing a rooting source for the at least one information; and
enabling modification of a content of a field corresponding to the at least one information within the rooting source.

2. The method of claim 1, wherein the displaying of the reference is provided simultaneously for multiple users.

3. The method of claim 1, wherein the at least one information corresponds to at least one field of a database, and the rooting source is a database.

4. A collaborative development system comprising:
a displaying unit for displaying a reference corresponding to at least one information relating to a development work;
an accessing unit for automatically accessing a rooting source of the at least one information upon selection by a user of the reference; and
an updater unit for enabling modification of a content of a field corresponding to the at least one information within the rooting source.

5. The collaborative development system of claim 4 wherein said updater unit and said accessing unit are available through a user interface.

6. The collaborative development system of claim 4 wherein said updater unit is available through a user interface.

7. The collaborative development system of claim 4 wherein said accessing unit is adapted to display a history of changes made to the content of the at least one field corresponding to the at least one information.

8. The collaborative development system of claim 7 wherein said history of changes is stored in a database.

9. The collaborative development system of claim 4 further comprising a user configuration unit to manage user access to content of the at least one field.

10. The collaborative development system of claim 4 further comprising a communication network for connecting to the rooting source.

11. The collaborative development system of claim 10 wherein said rooting source is remotely accessed by a user interface.

12. The collaborative development system of claim 10 wherein said accessing unit is a portal.

13. The collaborative development system of claim 4 wherein the displaying unit, the accessing unit and the updater unit are implemented as software.
